(19) United States
(12) Patent Application Publication
(10) Pub. No.: US 2024/0103791 A1
(43) Pub. Date: Mar. 28, 2024

(54) DISPLAY CONTROL METHOD AND DEVICE

(71) Applicant: Lenovo (Beijing) Limited, Beijing (CN)

(72) Inventor: Yakun YOU, Beijing (CN)

(21) Appl. No.: 18/461,108

(22) Filed: Sep. 5, 2023

(30) Foreign Application Priority Data
Sep. 26, 2022 (CN) 202211173146.7

(51) Int. Cl. G06F 3/14

(52) U.S. Cl. CPC G06F 3/1423

(57) ABSTRACT

A display control method includes determining a first display object and a second display object based on current display content, determining a first display screen and a second display screen based on display configuration information, and controlling a first display content corresponding to the first display object to be displayed on the first display screen and a second display content corresponding to the second display object to be displayed on the second display screen.

### CROSS-REFERENCE TO RELATED APPLICATION

The present disclosure claims priority to Chinese Patent Application No. 202211173146.7, filed on Sep. 26, 2022, the entire content of which is incorporated herein by reference.

### TECHNICAL FIELD

The present disclosure relates to the information processing technology field and, more particularly, to a display control method and a display control device.

### BACKGROUND

With the development of computer technology, more users obtain information through networks. For example, users can watch videos through a browser. The videos are often displayed on full screen. However, the original contents of the browser are often blocked by the videos displayed on the full screen. Users cannot obtain the original contents of the browser. If users need to look up these contents, the videos need to exit the full-screen mode. Thus, the operation is complicated. If the videos are displayed in a small display area, users cannot watch the videos on full screen, which lowers the user experience.

### SUMMARY

Embodiments of the present disclosure provide a display control method. The method includes determining a first display object and a second display object based on current display content, determining a first display screen and a second display screen based on display configuration information, and controlling a first display content corresponding to the first display object to be displayed on the first display screen and a second display content corresponding to the second display object to be displayed on the second display screen.

Embodiments of the present disclosure provide a display control device, including a first determination unit, a second determination unit, and a control unit. The first determination unit is configured to determine a first display object and a second display object based on current display content. The second determination unit is configured to determine a first display screen and a second display screen based on display configuration information. The control unit is configured to control a first display content corresponding to the first display object to be displayed on the first display screen and a second display content corresponding to the second display object to be displayed on the second display screen.

Embodiments of the present disclosure provide an electronic device, including one or more processors and one or more memories. The one or more memories store a computer program that, when executed by the one or more processors, causes the one or more processors to determine a first display object and a second display object based on current display content, determine a first display screen and a second display screen based on display configuration information, and control a first display content corresponding to the first display object to be displayed on the first display screen and a second display content corresponding to the second display object to be displayed on the second display screen.

### BRIEF DESCRIPTION OF THE DRAWINGS

FIG. 1 illustrates a schematic flowchart of a display control method according to some embodiments of the present disclosure.

FIG. 2 illustrates a schematic diagram of current display content according to some embodiments of the present disclosure.

FIG. 3 illustrates a schematic diagram of an application scenario displayed by a video according to some embodiments of the present disclosure.

FIG. 4 illustrates a schematic structural diagram of a display control device according to some embodiments of the present disclosure.

### DETAILED DESCRIPTION OF THE EMBODIMENTS

The technical solutions of embodiments of the present disclosure are described in detail in connection with the accompanying drawings of embodiments of the present disclosure. Apparently, embodiments are only some embodiments of the present disclosure, not all embodiments. Based on the embodiment of the present disclosure, all other embodiments obtained by those skilled in the art without any creative effort are within the scope of the present disclosure.

Embodiments of the present disclosure provide a display control method. The method can be applied in a scenario of browsing information through an electronic device. The electronic device can include a display screen and can display the browsed information through the display screen. In some embodiments, through a browser application of the electronic device, the video can be searched and then displayed or can be displayed through a client corresponding to a piece of specific information, e.g., an application scenario of displaying the video through the video client. Accordingly, in embodiments of the present disclosure, the information that is displayed can include at least one of video information or text information. In some embodiments, the information can be a video image and comment information corresponding to the video image, or text information from different information sources, such as document information and online translation information for the document. In embodiments of the present disclosure, display contents corresponding to different display objects can be displayed through different display screens of the electronic device, which improves the display effect.

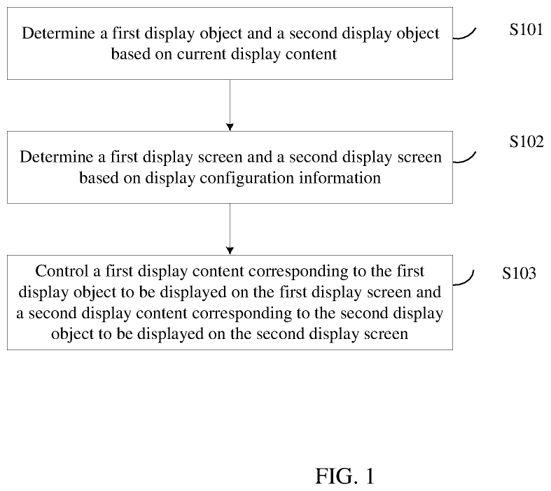

FIG. 1 illustrates a schematic flowchart of a display control method according to some embodiments of the present disclosure. The method can include the following steps.

At S101, based on current display content, a first display object and a second display object are determined.

The current display content can refer to the content displayed on a main display screen of the electronic device. The electronic device can include at least one screen. The screen can be a physical screen. That is, the electronic device can include at least two physical screens, obtain a plurality of display screens by being connected to external display screens, or obtain display screens by performing screen division on the display screen of the electronic device. Further, the main display screen can be the default display screen of the electronic device or a display screen with the highest display priority set by the user. The current display content can be a display content obtained based on the browser application installed on the operating system of the electronic device or a display content obtained through the client of the electronic device. The display content can have same or different formats. For example, the current display content can include the video image and the text comment information. The current display content can also include a text content from a first search page and a text content from a second search page.

When the display object is determined based on the current display content, parsing can be performed on the content format of the current display content to determine different display objects. Different display objects can be determined according to the information sources of the display contents. Further, different display objects can be determined according to the operations of the user performed on the current display content. By determining different display objects, a display method corresponding to the current display information can be matched automatically based on the current display information, which improves the display effect.

In embodiments of the present disclosure, the display content can be distinguished merely using the first display object and the second display object. If the current electronic device includes two or more display screens, the display content can be further divided. If the electronic device includes three display screens, the display content can be divided into the first display object, the second display object, and the third display object. If the electronic device only includes two display screens, the most important interaction information of the user can be used as the first display object, and other information can be used as the second display object.

In embodiments of the present disclosure, determining the first display object and the second display object based on the current display content can include obtaining operation information for the current display content and determining the first display object and the second display object based on the operation information. The operation information for the current display content can be the operation information of the user of the electronic device for the display content, for example, the interaction information of the specific display content including, i.e., information generated by an operation of selecting, adjusting, or inputting performed on feature information, or the operation information of selection of the user performed on the display mode, e.g., control information of the user for selecting “automatic adjustment display mode.” In some embodiments, a display object with a high user operation frequency can be determined as the first display object. The information of the current display content except the first display object can be determined as the second display object. When the display object is determined according to the operation information of the user, if the user always switches between two web page contents, a first web page can be determined as the first display object, and a second web page can be determined as the second display object.

Further, determining the first display object and the second display object based on operation information can include if the operation information includes full-screen operation information for a video, determining the video corresponding to the full-screen operation information as the first display object, and determining display information other than the video of the current display content as the second display object.

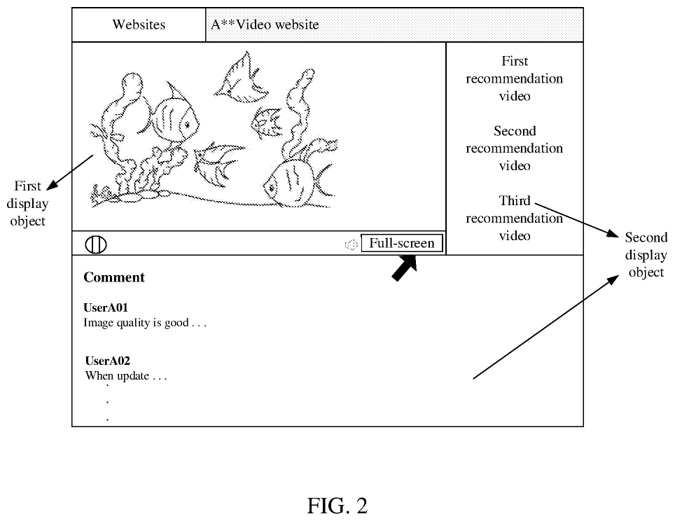

FIG. 2 illustrates a schematic diagram of the current display content according to some embodiments of the present disclosure. When the user clicks a “full-screen” button, the current video image is displayed in full-screen mode. However, in full-screen mode, recommendation video information and comment information shown in FIG. 2 are not viewed. Thus, the user may need to exit the full-screen mode to browse the recommendation video information and the comment information. Therefore, in embodiments of the present disclosure, the video image corresponding to the full-screen operation can be determined as the first display object, and the comment information and the recommendation video information corresponding to the video can be determined to be the second display object. In the subsequent display processing process, the first display object and the second display object can be matched and displayed. For example, the first display object and the second display object can be displayed on different display screens. Thus, the full-screen browsing requirement of the user can be satisfied, and the user can also browse the other information.

At S102, based on display configuration information, the first display screen and the second display screen are determined.

At S103, the first display content corresponding to the first display object is controlled to be displayed on the first display screen, and the second display content corresponding to the second display object is controlled to be displayed on the second display screen.

The display configuration information can include configuration information of the electronic device for the display screens, such as connection configuration information, split-screen control information, and screen display parameter configuration information. In some embodiments, the processor of the electronic device can store the display configuration information and be configured to determine related information of the current display screens of the electronic device through the display configuration information or determine whether the electronic device is able to be connected to an eternal display screen through an interface through the display configuration information. The processor can be further configured to determine whether the display screen of the current electronic device is able to be divided through the display configuration information and sizes of display areas after dividing the display screen. The electronic device can include a main display screen and an auxiliary display screen. The auxiliary display screen can be an external physical display screen connected to the electronic device through the system interface or a virtual display screen generated through projection or virtual reality technology.

After determining the first display object and the second display object according to the current display content, display screens corresponding to the display objects can be matched based on the display configuration information to display the display content. In some embodiments, determining the first display screen and the second display screen based on the display configuration information can include obtaining the display screen connection configuration information of the electronic device and determining the first display screen and the second display screen of the electronic device based on the display screen connection configuration information. The display screen connection configuration information can include interface connection configuration information between the electronic device and the display screen or display device. For example, whether the electronic device can be connected to the display screen or display device in a wired mode or a wireless mode. An interface quantity can be used to determine the quantity of the display screens. The interface type can be used to determine the type of the connected display screen. Thus, the display screens that are able to display different display objects can be determined according to the display screen connection configuration information. For example, a display screen with high display accuracy can be selected to display the display content corresponding to the display object, i.e., a video. For another example, according to the network connection information of the display screen, the display screen with high network transmission efficiency can be selected to display the display content corresponding to the display object that is updated in real-time.

Further, when the electronic device includes the plurality of display screens, determining the first display screen and the second display screen can include obtaining the first display mode of the first display object and the second display mode of the second display object and, based on the first display mode and the second display mode, determining the first display screen and the second display screen from the plurality of display screens of the electronic device. The display configuration parameter of the first display screen can match the first display mode, and the display configuration parameter of the second display screen can match the second display mode.

A display mode can be an output mode for the display content corresponding to the display object. For example, the display mode corresponding to the display content can be determined according to the information source of the display content corresponding to the display object. In some embodiments, the information source can include a to-be-displayed format and a to-be-transmitted format of the display content. Thus, the determined display screen can better match the display mode of the display object to improve the display effect.

The first display content corresponding to the first display object and the second display content corresponding to the second display object can be real-time or updated display content. For example, the first display object can be a video, and the second display object can be the comment information for the video. The video content can be displayed on the first display screen, and the comment information can be displayed on the second display screen. The first display screen can display the video content being streamed in real-time. The second display screen can display the current comment information. In some other embodiments, if the comment information is updated while watching the video, the second display screen can display the updated comment information.

To better satisfy the user requirement when different display screens display different display contents, an entering processing mode and an exiting processing mode can be set for the split-screen display (a display method of using different display screens to display the display content is referred to as the split-screen display). That is, if an operator selects to initiate the split-screen display, the display object can be automatically determined by analyzing the current display content, and the display contents of the different display objects can be displayed on the corresponding display screens. Correspondingly, if the user chooses to exit the split-screen display, the current display content can be displayed in a default display mode.

After determining the display screen corresponding to the display object, to output the display content of the display object on the display screen corresponding to the display object clearly, the display object may need to be adjusted according to the display format corresponding to the display screen. For example, an encoding processing and a decoding processing corresponding to the formats can be performed. In some embodiments, controlling the first display screen to display the first display content corresponding to the first display object and the second display screen to display the second display content corresponding to the second display object can include, in response to adjusting the first display object to the display format corresponding to the first display screen, controlling the display content corresponding to the first display object with the adjusted display format to be displayed on the first display screen, and in response to adjusting the second display object to a display format corresponding to the second display screen, controlling the display content corresponding to the second display object with the updated display format to be displayed on the second display screen.

Based on the above, the display control method is described by taking the user operation information being the full-screen operation on the video as an example. In some embodiments, the user can have the requirement to watch the video through a small window and browse other information. The small window can have a small area to display the video, which affects the user viewing experience. Thus, in embodiments of the present disclosure, if small window operation information for the current display content is detected, the current display content can be switched to a different display screen for display. The small window operation information can refer to displaying the current video in a window smaller than the size of the full screen floating on the desktop. Correspondingly, if the small window has a small size, the user can be affected to browse the information in the small window. If the size of the small window is too big, the browsing effect for the other information in the current display interface other than the small window can be affected. Thus, in embodiments of the present disclosure, after the user small window operation for the current display content is detected, the split-screen display can be automatically performed.

In some embodiments, determining the first display object and the second display object based on the operation information can include, if the operation information includes operation information of displaying the video in a target window, determining the video displayed in the target window as the first display object and determining the display information outside the target window of the current display content as the second display object. The target window can have an area smaller than an area of the current display interface.

Further, controlling the first display content corresponding to the first display object to be displayed on the first display screen can include determining the quantity of the target windows and determining the quantity of the first display screens corresponding to the quantity of the target windows to display the first display content corresponding to each target window on the first display screen corresponding to the first display content. That is, when a plurality of target windows are included, the display screen corresponding to each of the target windows can be determined. For example, two target windows can be included, i.e., the first target window and the second target window. Two first display screens may be needed. One of the first display screens can display the content in the first target window. The other one of the first display screens can display the content in the second target window.

If the electronic device includes a plurality of physical screens, the display contents corresponding to different display objects can be directly displayed on the plurality of physical screens. For example, a first physical screen can display the video, and a second display screen can display text introduction of the scene corresponding to the video.

If the current electronic device only has one display screen, the display screen can be divided to display the display contents. However, in this method, the user may need to be prompted whether to display the display contents based on the sizes of the display screen area after the division. Thus, the user experience can be improved. Correspondingly, in some embodiments, determining the first display screen and the second display screen based on the display configuration information can include obtaining size information of the current display screen where the current display content is displayed, determining an area threshold for the display area based on the size information, obtaining a first area of the first display area corresponding to the first display object and a second area of the second display area corresponding to the second display object, if the first area and/or the second area is smaller than the area threshold of the display area, dividing the current display screen based on the area threshold of the display area to obtain the first display screen and the second display screen. The first display screen and the second display screen can have a same configuration parameter.

In some embodiments, if the current display content includes the small window information display, or the default display area is small, the display content can be displayed by dividing the single display screen. That is, the display area after the display screen is divided according to the area threshold of the target display area can satisfy the user browsing requirement, and display contents of the different display objects can be displayed by dividing the single display screen. If the user requirement cannot be satisfied, the display contents can be displayed by connecting the electronic device to a plurality of physical display screens.

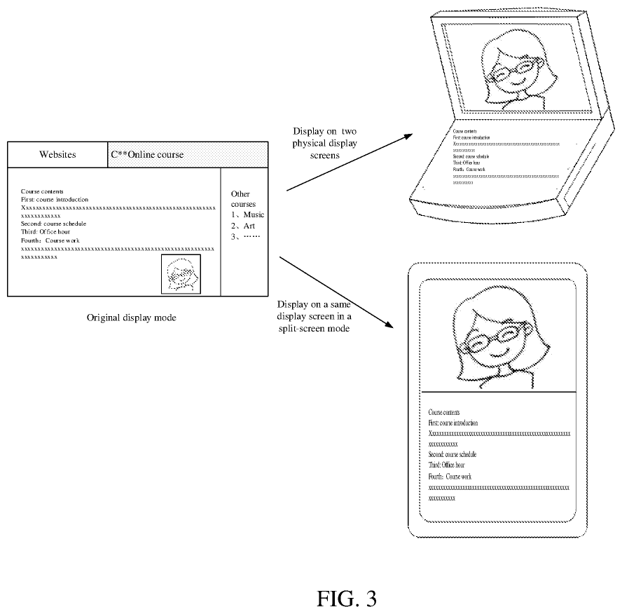

FIG. 3 illustrates a schematic diagram of an application scenario displayed by a video according to some embodiments of the present disclosure. In the main display screen of the current electronic device, the user uses a small window to display information. The small window displays the real-time video image when an online teacher teaching. The text content of the online course can be displayed in the display area outside the small window. However, since the small window has a small size, students cannot see action representation of the teacher well. In embodiments of the present disclosure, the display control method can include detecting the interface configuration information of the electronic device by the processor the electronic device, and determining whether the electronic device includes the main display screen and other display screens (e.g., physical display screens or virtual display screens generated through projection or virtual reality technology. Then, the electronic device can be determined to be in a multi-screen display mode. The method can further include recognizing the mode automatically through the image displaying the content information to determine whether a part of the content in the current display area is displayed in the second display screen, and if an image area with a suitable content (e.g., the text content in FIG. 3) is detected, extracting the area automatically to display the display content corresponding to the area on the second display screen. If the current video image does not include a content that needs to be displayed on another display screen, the content of other parts of the web page, e.g., the online translation content, can be extracted to be displayed on the second display screen, and the web page part can be maintained to be continuously rendered.

In some other embodiments, if the electronic device is detected to include only one main display screen, and the maximum size of the small window is also smaller than the size of the split-screen of the main display screen, the display content can be displayed in the split-screen display mode. For example, the main display screen can be divided into two display areas, i.e., an upper display area and a lower display area. The real-time image when the teacher teaches can be displayed in the upper display area, and the text content can be displayed in the display area.

By applying the display control method of embodiments of the present disclosure to the scenario of browsing the information, when the user watches a browser video using an external or dual-screen device, the user can watch the video while reading the comment to maximize the advantage of the dual screen. When the user watches the video through the picture-in-picture of the small window, a part of the small image can be maximized and displayed using the second display screen, which is more suitable for online courses and games. Thus, the display effect can be improved, and the user experience can be improved.

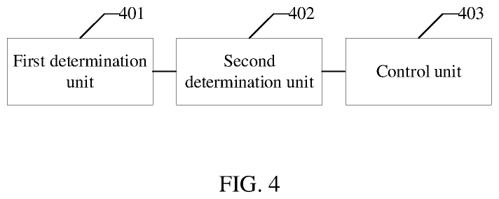

As shown in FIG. 4, embodiments of the present disclosure further provide a display control device, including a first determination unit 401, a second determination unit 402, and a control unit 403.

The first determination unit 401 can be configured to determine the first display object and the second display object based on the current display content.

The second determination unit 402 can be configured to determine the first display screen and the second display screen based on the display configuration information.

The control unit 403 can be configured to control the first display screen to display the first display content corresponding to the first display object, and the second display screen to display the second display content corresponding to the second display object.

Embodiments of the present disclosure further provide a display control device. The method can include the first determination unit configured to determine the first display object and the second display object based on the current display content, the second determination unit configured to determine the first display screen and the second display screen based on the display configuration information, and the control unit configured to control the first display content corresponding to the first display object to be displayed in the first display screen and control the second display content corresponding to the second display object to be displayed in the second display screen. In the present disclosure, based on the display contents, the display objects can be automatically adjusted to be displayed on different display screens, which improves the display effect.

In some embodiments, the first determination unit can include a first acquisition subunit and a first determination subunit.

The first acquisition subunit can be configured to obtain the operation information for the current display content.

The first determination subunit can be configured to determine the first display object and the second display object based on the operation information.

In some embodiments, the first determination subunit can be configured to, if the operation information includes full-screen operation information for the video, determine the video corresponding to the full-screen operation information as the first display object and determine the display information outside the video in the current display content as the second display object.

In some embodiments, the first determination subunit can be further configured to, if the operation information includes the operation information for displaying the video in the target window, determine the video displayed in the target window as the first display object and determine the display information outside the target window in the current display content as the second display object. The area of the target window can be smaller than the area of the current display interface.

The control unit can include a second determination subunit and a third determination subunit. The second determination subunit can be configured to determine the quantity of the target window. The third determination subunit can be configured to determine the quantity of the first display screens corresponding to the quantity of the target windows to cause the first display content corresponding to the target window to be displayed on the first display screen corresponding to the target window.

In some embodiments, the control unit can further include a first control subunit and a second control subunit.

The first control subunit can be configured to, in response to adjusting the first display object to the display format corresponding to the first display screen, control the first display content corresponding to the first display object with the adjusted display format to be displayed on the first display screen.

The second control sub-unit can be configured to, in response to adjusting the second display object to the display format corresponding to the second display screen, control the second display content corresponding to the second display object with the adjusted display format to be displayed on the second display screen.

In some embodiments, the first determination unit can include a second acquisition subunit and a fourth determination subunit.

The second acquisition subunit can be configured to obtain the display screen connection configuration information of the electronic device where the current display content is displayed.

The fourth determination unit can be configured to determine the first display screen and the second display screen of the electronic device based on the display screen connection configuration information.

In some embodiments, the electronic device can include a plurality of display screens. The second determination unit can include a third acquisition subunit and a fifth determination subunit.

The third acquisition subunit can be configured to obtain the first display mode of the first display object and the second display mode of the second display object.

The fifth determination subunit can be configured to determine the first display screen and the second display screen from the plurality of display screens of the electronic device based on the first display mode and the second display mode.

The display configuration parameters of the first display screen can match the first display mode, and the display configuration parameters of the second display screen can match the second display mode.

Further, the second determination subunit can be configured to:
obtain the size information of the current display screen where the current display content is located;
based on the size information, determine the area threshold of the target display area;
obtain the first area of the first display area corresponding to the first display object and the second area of the second display area corresponding to the second display object; and
if the first area and/or the second area are smaller than the area threshold of the target display area, divide the current display screen based on the area threshold of the target display area to obtain the first display screen and the second display screen, the first display screen and the second display screen having the same configuration parameter.

For specific implementations of the various units and subunits of embodiments of the present disclosure, reference can be made to the corresponding content above, which is not repeated here.

In some other embodiments of the present disclosure, a readable storage medium can be provided. The readable storage medium can store a computer program that, when executed by a processor, causes the processor to perform the steps of the display control method.

In some other embodiments of the present disclosure, an electronic device can be provided. The electronic device can include a memory and a processor.

The memory can be used to store an application program and data generated when the application program is running.

The processor can be configured to execute the application program to implement the display control method above.

For the specific implementation of the processor of embodiments of the present disclosure, reference can be made to the corresponding content above, which is not repeated here.

Embodiments of the present disclosure are described in a progressive manner. Each embodiment focuses on the differences from the other embodiments. Similar or identical parts between different embodiments can be cross-referenced. For the device of embodiments of the present disclosure, since the device corresponds to the method of embodiments of the present disclosure, the device is simply described. For related parts, reference can be made to the description of the method.

Those skilled in the art can further realize that the units and algorithm steps of embodiments of the present disclosure can be implemented by electronic hardware, computer software, or a combination thereof. To describe the interchangeability between the hardware and the software, embodiments of the present disclosure are generally described according to the functions. Whether these functions are implemented by the hardware or software can depend on the specific application and design constraints of the technical solution. Those skilled in the art can implement the described functions in different methods, which should not be considered beyond the scope of the present disclosure.

The method or algorithm steps described in embodiments of the present disclosure can be implemented directly by hardware, software module performed by the processor, or a combination thereof. The software module can be stored in random access memory (RAM), memory, read-only memory (ROM), electrically programmable ROM, electrically erasable programmable ROM, registers, hard drives, removable disks, CD-ROMs, or any other form of storage medium known in the art.

The description of embodiments of the present disclosure enables those skilled in the art to implement or use the present disclosure. Various modifications to embodiments of the present disclosure are apparent to those skilled in the art. The general principles defined here can be implemented in other embodiments without departing from the spirit or scope of the present disclosure. Therefore, the present disclosure is not limited to embodiments of the present disclosure but conforms to the broadest scope consistent with the principles and novel features of the present disclosure.

What is claimed is:

1. A display control method comprising:
determining a first display object and a second display object based on current display content;
determining a first display screen and a second display screen based on display configuration information; and
controlling a first display content corresponding to the first display object to be displayed on the first display screen and a second display content corresponding to the second display object to be displayed on the second display screen.

2. The method according to claim 1, wherein determining the first display object and the second display object based on the current display content includes:
obtaining operation information for the current display content; and
determining the first display object and the second display object based on the operation information.

3. The method according to claim 2, wherein determining the first display object and the second display object based on the operation information includes:
in response to the operation information including full-screen operation information for a video, determining the video corresponding to the full-screen operation information as the first display object; and
determining display information outside the video of the current display content as the second display object.

4. The method according to claim 2, wherein determining the first display object and the second display object based on the operation information includes:
in response to the operation information including operational information for displaying a video in a target window, determining the video displayed in the target window as the first display object, an area of the target window being smaller than an area of a current display interface; and
determining display information outside the target window of the current display content as the second display object.

5. The method according to claim 4, wherein controlling the first display content corresponding to the first display object to be displayed on the first display screen includes:
determining a quantity of target windows; and
determining a quantity of first display screens corresponding to the quantity of the target windows to cause the first display content corresponding to each target window to be displayed on the first display screen corresponding to the target window.

6. The method according to claim 1, wherein controlling the first display content corresponding to the first display object on the first display screen and the second display content corresponding to the second display object on the second display screen includes:
in response to adjusting the first display object to a display format corresponding to the first display screen, controlling the first display content corresponding to the first display object with the adjusted display format to be displayed on the first display screen; and
in response to adjusting the second display object to a display format corresponding to the second display screen, controlling the second display content corresponding to the second display object with the adjusted display format to be displayed on the second display screen.

7. The method according to claim 1, wherein determining the first display screen and the second display screen based on the display configuration information includes:
obtaining display screen connection configuration information of an electronic device on which the current display content is displayed;
determining the first display screen and the second display screen of the electronic device based on the display screen connection configuration information.

8. The method according to claim 7, wherein:
the electronic device includes a plurality of display screens; and
determining the first display screen and the second display screen of the electronic device includes:
obtaining a first display mode of the first display object and a second display mode of the second display object; and
determining the first display screen and the second display screen from the plurality of display screens of the electronic device based on the first display mode and the second display mode, wherein a display configuration parameter of the first display screen matches the first display mode, and a display configuration parameter of the second display screen matches the second display mode.

9. The method according to claim 1, wherein determining the first display screen and the second display screen based on the display configuration information includes:
obtaining size information of a current display screen displaying the current display content;
determining an area threshold of a target display area based on the size information;
obtaining a first area of a first display area corresponding to the first display object and a second area of a second display area corresponding to the second display object; and
in response to the first area and/or the second area being smaller than an aera threshold, dividing the current display screen based on the area threshold to obtain the first display screen and the second display screen, the first display screen and the second display screen having a same configuration parameter.

10. A display control device comprising:
a first determination unit configured to determine a first display object and a second display object based on current display content;
a second determination unit configured to determine a first display screen and a second display screen based on display configuration information;
a control unit configured to control a first display content corresponding to the first display object to be displayed on the first display screen and a second display content corresponding to the second display object to be displayed on the second display screen.

11. The device according to claim 10, wherein determining the first determination unit is further configured to:
obtain operation information for the current display content; and
determine the first display object and the second display object based on the operation information.

12. An electronic device comprising:
one or more processors; and
one or more memories storing a computer program that, when executed by the one or more processors, causes the one or more processors to:
determine a first display object and a second display object based on current display content;
determine a first display screen and a second display screen based on display configuration information; and
control a first display content corresponding to the first display object to be displayed on the first display screen and a second display content corresponding to the second display object to be displayed on the second display screen.

13. The electronic device according to claim 12, wherein the one or more processors are further configured to:
obtain operation information for the current display content; and
determine the first display object and the second display object based on the operation information.

14. The electronic device according to claim 13, wherein the one or more processors are further configured to:
in response to the operation information including full-screen operation information for a video, determine the video corresponding to the full-screen operation information as the first display object; and
determine display information outside the video of the current display content as the second display object.

15. The electronic device according to claim 13, wherein the one or more processors are further configured to:
in response to the operation information including operational information for displaying a video in a target window, determine the video displayed in the target window as the first display object, an area of the target window being smaller than an area of a current display interface; and
determine display information outside the target window of the current display content as the second display object.

16. The electronic device according to claim 15, wherein the one or more processors are further configured to:
determine a quantity of target windows; and
determine a quantity of first display screens corresponding to the quantity of the target windows to cause the first display content corresponding to each target window to be displayed on the first display screen corresponding to the target window.

17. The electronic device according to claim 12, wherein the one or more processors are further configured to:
in response to adjusting the first display object to a display format corresponding to the first display screen, control the first display content corresponding to the first display object with the adjusted display format to be displayed on the first display screen; and
in response to adjusting the second display object to a display format corresponding to the second display screen, control the second display content corresponding to the second display object with the adjusted display format to be displayed on the second display screen.

18. The electronic device according to claim 12, wherein the one or more processors are further configured to:
obtain display screen connection configuration information of an electronic device on which the current display content is displayed;
determine the first display screen and the second display screen of the electronic device based on the display screen connection configuration information.

19. The electronic device according to claim 12, further comprising a plurality of display screens, wherein:
the one or more processors are further configured to:
obtain a first display mode of the first display object and a second display mode of the second display object; and
determine the first display screen and the second display screen from the plurality of display screens of the electronic device based on the first display mode and the second display mode, wherein a display configuration parameter of the first display screen matches the first display mode, and a display configuration parameter of the second display screen matches the second display mode.

20. The electronic device according to claim 12, wherein the one or more processors are further configured to:
obtain size information of a current display screen displaying the current display content;
determine an area threshold of a target display area based on the size information;
obtain a first area of a first display area corresponding to the first display object and a second area of a second display area corresponding to the second display object; and
in response to the first area and/or the second area being smaller than an aera threshold, divide the current display screen based on the area threshold to obtain the first display screen and the second display screen, the first display screen and the second display screen having a same configuration parameter.
